(19) United States
(12) Patent Application Publication
(10) Pub. No.: US 2021/0148324 A1
(43) Pub. Date: May 20, 2021

(54) MULTICONFIGURATION IGNITION COIL

(71) Applicant: Bradley Sheridan, Glendora, CA (US)

(72) Inventor: Bradley Sheridan, Glendora, CA (US)

(21) Appl. No.: 17/099,384

(22) Filed: Nov. 16, 2020

Related U.S. Application Data
(60) Provisional application No. 62/935,202, filed on Nov. 14, 2019.

(51) Int. Cl. F02P 9/00; F02P 3/09; F02P 1/08; B60R 16/02

(52) U.S. Cl. CPC F02P 9/007; B60R 16/0207; F02P 1/086; F02P 3/09

(57) ABSTRACT

An apparatus having an ignition coil. The ignition coil has a transformer; a housing; a high voltage output; a wiring harness connector; and two or more input terminals. At least one of the two or more input terminals are electrically coupled to the wiring harness connector and electrically isolated from the transformer. The transformer is electrically connected to the wiring harness connector.

### FIELD OF THE INVENTION

Spark ignition based internal combustion engines use an ignition coil to create the high voltage spark, and some control method to control the coil to create the spark. These control methods require several wires to interface from the car and the ignition controller to the coil. A common method of improving the ignition performance has been to add a capacitive discharge (hereinafter CD) ignition into an existing ignition circuit. These are added by wiring them into the wiring harness between the ignition controller and the coil. Other methods of improving the ignition performance involve increasing the voltage supply to the coil, or adjusting the control signal to the coil (dwell).

### BACKGROUND OF THE INVENTION

For decades, the CD ignition has been a common aftermarket item added to engines in automotive and other applications. These provide improvements of several spark characteristics, with the goal of improving the operation of the engine. These CD ignitions are added to an existing ignition system by splicing in several wires between the car wiring and ignition controller (points, electronic, or other) and the coil. These wires are cut/intercepted individually by the installer, who is often the vehicle owner with limited understanding of the ignition electronics. Incorrectly connecting any of this wiring could cause malfunction and/or damage to the car, CD ignition, or both. Incorrect wiring is a common problem that people encounter when performing any of these ignition upgrades.

The most common way to increase the voltage to the coil has been to add a relay directly to the battery. This eliminates all the voltage losses in the original wiring to the coil, through the stock wires, ignition switch and other wiring. Installing this involves intercepting/modifying the wires to the ignition coil. An alternative method to improve the voltage could utilize a voltage boosting power source could be used in place of the relay.

One other common method of improving the ignition is adjusting the signal to the coils. The OEM ignition system was typically triggered off mechanical points. Points provide less power to the coil as the RPM climbs and the most power to the coil at low RPM. Adding an electronic circuit that optimizes the control signal, can give a consistent amount of power for each spark to the coil at all RPM.

The common feature of all the methods is that they are altering the voltages on the wires to the coil. Current methods for install treat each uniquely. A properly designed installation could commonize the install, and make it easy to reverse or change. And it could also simplify the install so that there is no risk of mistakes.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 shows a prior art embodiment of a typical automotive ignition coil.

FIG. 2 shows a prior art embodiment of a typical automotive ignition coil with a CD ignition wired externally in the normal fashion.

FIG. 3 shows a multiple configuration coil (hereinafter multicoil) that integrates the CD wiring changes into the coil, allowing the coil to be set up and used in different ignition configurations.

FIG. 4 shows a multiple configuration coil cap (hereinafter multicoil cap) for a standard automotive ignition coil, to effectively integrate the CD ignition wiring changes into the coil.

FIG. 5 shows a switchable multiple configuration coil (hereinafter switchable multicoil) that integrates the CD wiring into the coil, and also includes a built in multi pole selector switch to bypass the wiring and change the configuration.

FIG. 6 shows a prior art electrical schematic of a typical ignition coil wired for normal operation.

FIG. 7 shows the prior art electrical schematic of how to add the wiring for a CD Ignition into an existing typical ignition system wiring.

FIG. 8 shows the electrical schematic of the multicoil, and how it replaces the standard ignition coil.

FIG. 9 shows the use of a multicoil to integrate a relay or voltage booster into the ignition circuit

FIG. 10 shows the use of a multicoil to integrate an electronic ignition into the existing ignition wiring.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

Several definitions that apply throughout this disclosure will now be presented.

The term “coupled” is defined as coupled, whether directly or indirectly through intervening components, and is not necessarily limited to physical connections. The connection can be such that the objects are permanently coupled or releasably coupled. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like. The term “vehicle” includes motor vehicles (e.g., motorcycles, cars, trucks, buses), railed vehicles (e.g., trains, trams), watercraft (e.g., ships, boats), aircraft and spacecraft.

For simplification of the examples and explanations, they have all been drawn with the typical 12V automotive charging system with a negative ground. This is not meant to exclude 6V or 24V charging systems, or systems with a positive ground.

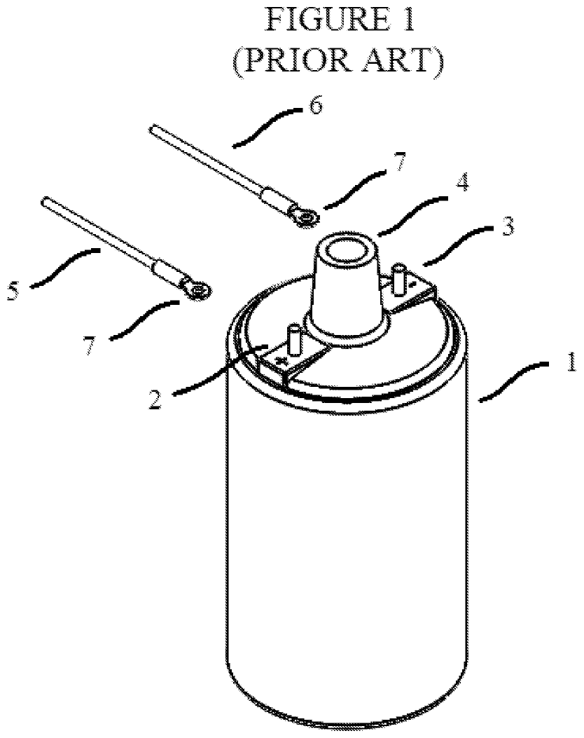

The multicoil is designed to simplify the process of integrating an ignition upgrade like a CD ignition into the existing wiring harness of a vehicle. A side benefit of the simplification is that it will reduce or eliminate the risk of damage to the CD ignition or the vehicle. It does this by emulating the original coil terminals 2 and 3 (see FIG. 1). All other wiring connections are made internally to the multicoil. This eliminates the need to modify the original wiring, since it requires simply removing the two terminal connections at the coil, and reattaching them to the multicoil. Future changes to the ignition system would be even easier, once the multicoil is installed.

FIG. 1 is prior art showing a standard ignition coil and the wiring that is originally attached to it. The ignition coil 1 has two terminals on the top (2,3) and a high voltage output 4 where the coil wire connects to the distributor (not shown) to deliver the spark voltage to the engine. There is a twelve volt (12V) power wire 5 that provides the operating voltage to the coil when the ignition is switched on. The 12V power wire 5 connects to the positive coil terminal 2 on the coil typically using a ring terminal 7. There is a coil signal/points wire 6 that is typically connected to points output from the distributor (not shown). The coil signal/points wire 6 connects to the coil negative (−) terminal 3 on the coil typically using a ring terminal 7, with a nut to secure the ring terminal to the coil post.

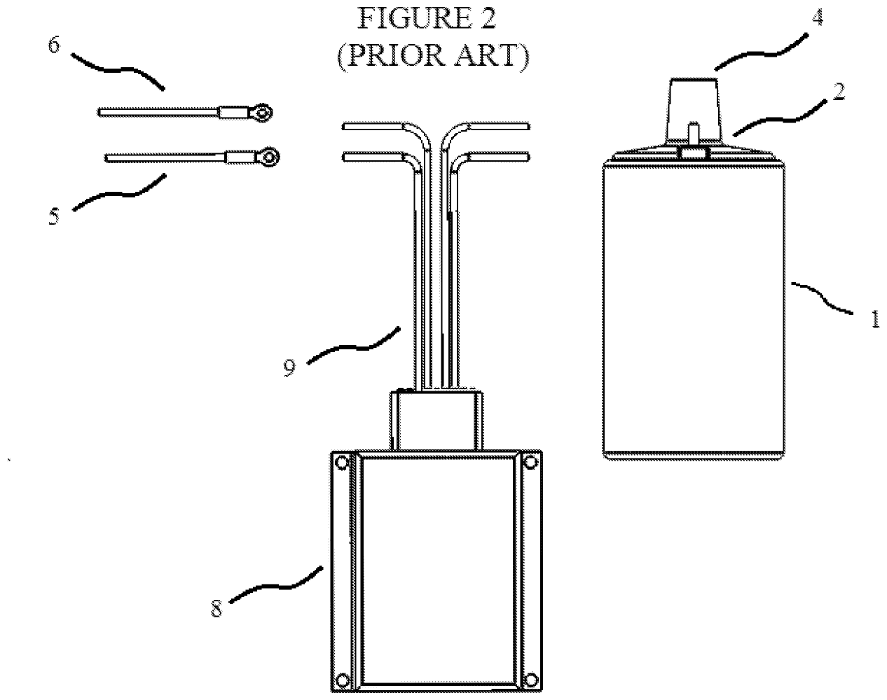

FIG. 2 is prior art showing the same standard ignition coil, but with a CD ignition 8 being added. In order to add the ignition, two wires have to be spliced to the 12V power wire 5 and the coil signal/points wire 6. Then two wires have to be connected to the coil terminals 2 and 3. Each of these four or more wire connections have to be made to the correct wire for the ignition to work properly. Incorrect wiring could lead to a damaged CD Ignition 8 or damaged vehicle wiring.

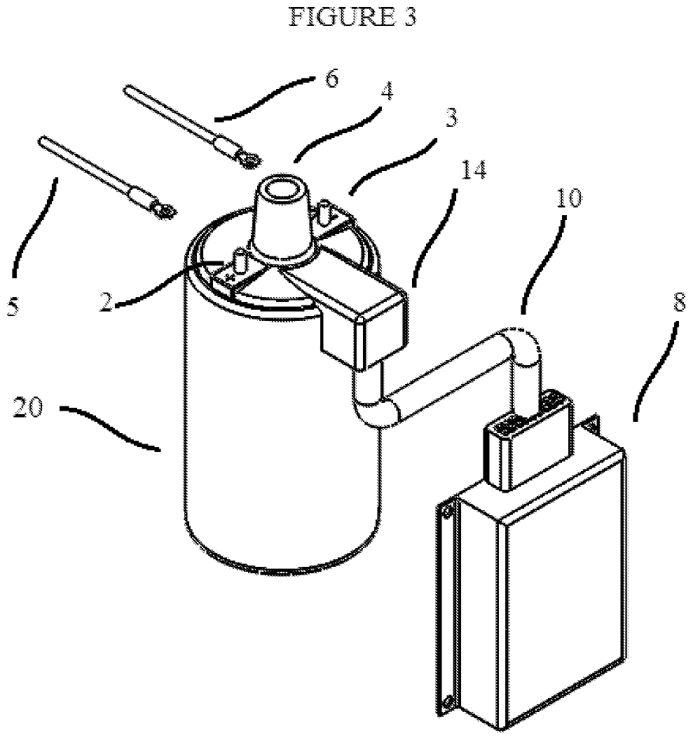

FIG. 3 shows a CD ignition installation with the multicoil. In the embodiment shown, the multicoil 20 has replaced the ignition coil 1. Installation is as simple as unbolting and replacing the original coil with the multicoil 20, and plugging the wire harness assembly 10 to the CD ignition 8 and the multicoil connector 14. The two wires from the original harness, 12V power wire 5 and coil signal/points wire 6, simply unbolt from the original coil, and bolt on to the analogous terminals on the multicoil 20. While the drawing shows a coil where the multicoil connector 14 is molded in to the multicoil, an alternative embodiment could include wires that act as the connector.

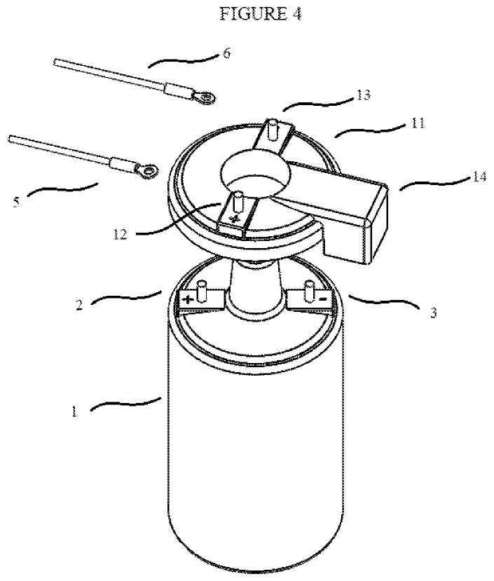

An alternative embodiment is shown in FIG. 4. An embodiment of the multicoil cap assembly 11 is designed so that it will sit on the existing ignition coil 1. The multicoil cap assembly 11 may be designed to be molded plastic or similar material that is designed for the automotive environment. The multicoil cap assembly 11 has receptacles built in that intercept the original coil terminals 2 and 3. The multicoil cap assembly 11 has terminals 12 and 13. Once the multicoil cap assembly 11 is installed onto the top of the coil, the 12V power wire 5 is connected to the multicoil positive terminal 12, and the coil signal/points wire 6 is connected to the multicoil negative terminal 13.

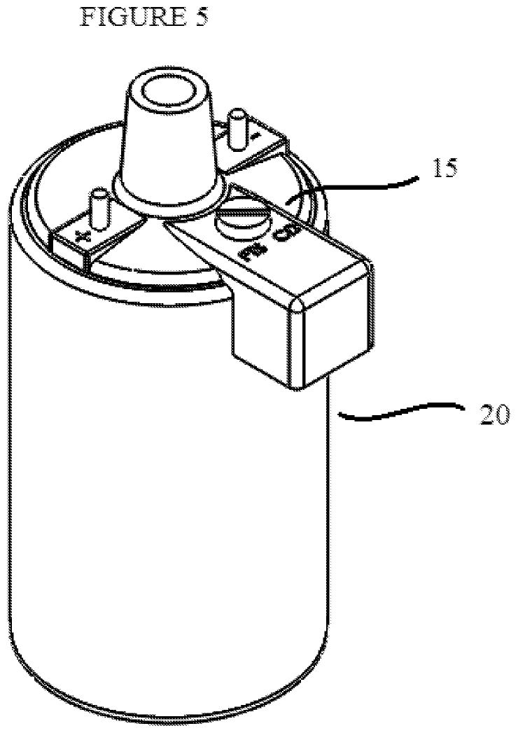

FIG. 5 shows an embodiment of the multicoil 20 with a selector switch 15. The selector switch 15 connects the multicoil internal ignition transformer to either the CD Ignition 8, or bypasses the CD Ignition wiring.

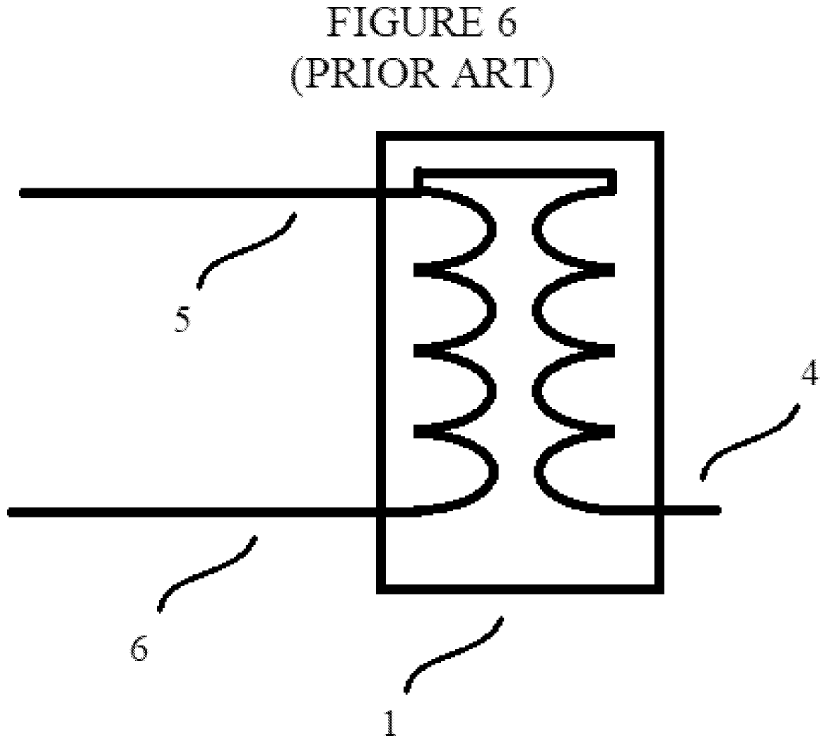

FIG. 6 is prior art that shows a schematic of a standard ignition coil 1 with the normal wiring from the vehicle. The 12V power wire 5 and coil signal/points wire 6 connect to the coil via electrical terminals.

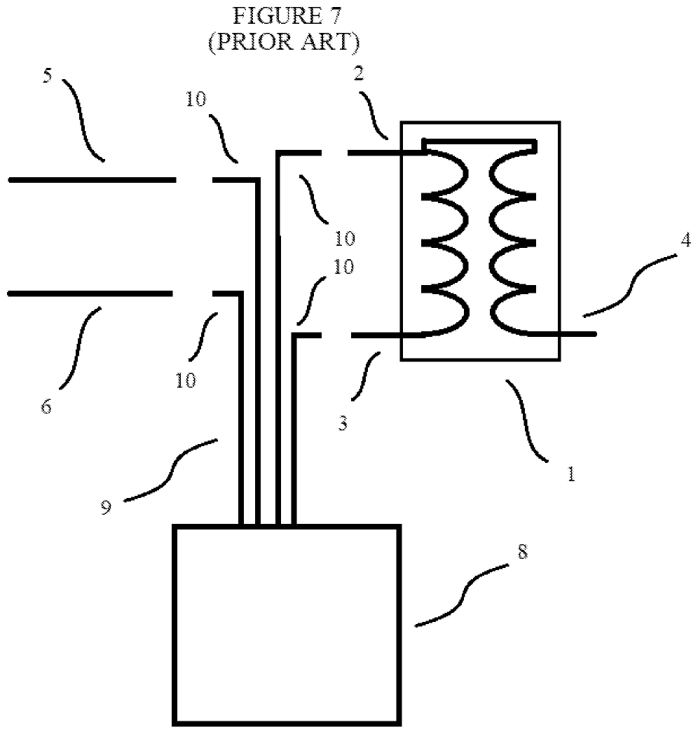

FIG. 7 is prior art that shows a typical schematic of how a CD Ignition 8 and harness 9 need to be added into the original vehicle ignition wiring harness. In this application, the two wires 5 and 6 that originally went to the coil negative are intercepted and connected to the CD Ignition harness 9. Two other wires from the CD Ignition harness now have to be wired to the ignition coil. In some installations, other wires may need to be added to get the installation working properly. Wiring for the tachometer often needs to be added.

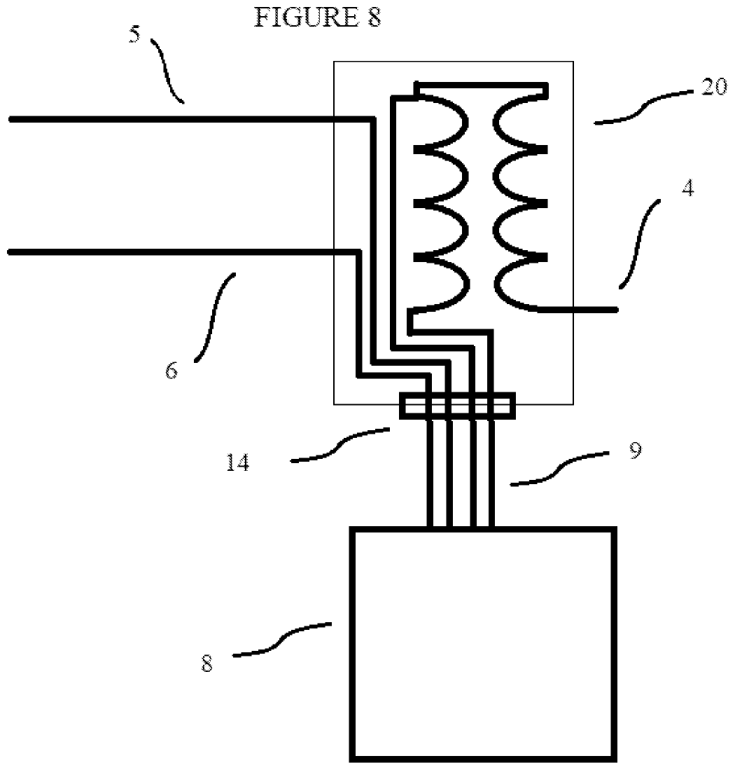

FIG. 8 shows a typical schematic of adding a CD Ignition 8 to the wiring using a multicoil 20. The wires go to the multicoil 20 exactly the same way as before the CD install. This is the basic schematic to get the CD ignition working. Additional components could be added to the schematic in the coil as needed to improve or add functionality of the system.

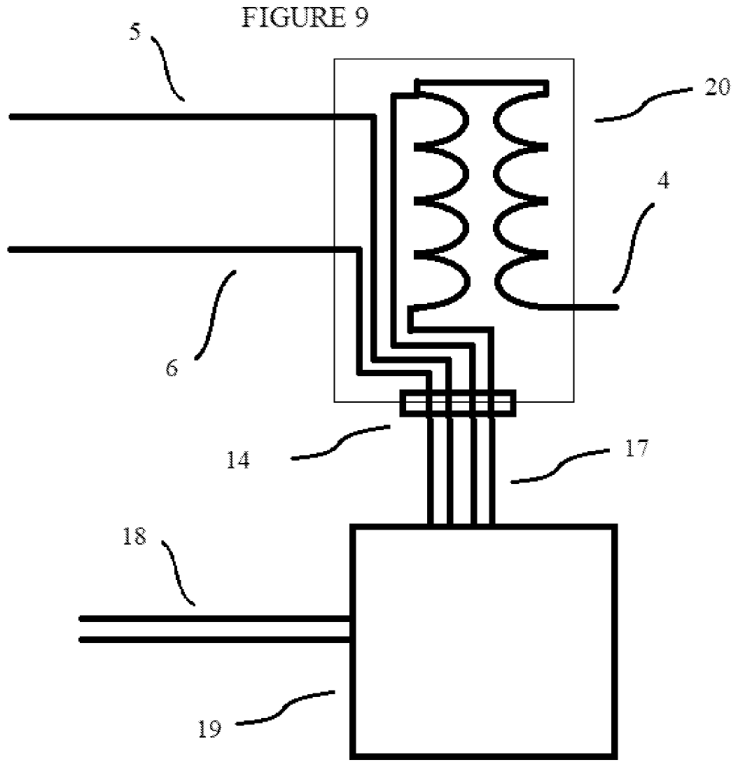

FIG. 9 shows a typical schematic of adding a relay or voltage booster 19 to the wiring using a multicoil. The wires 5 and 6 connect to the multicoil, in the same way as they had connected to the original ignition coil. In most cases, battery power wires 18 would also go to the relay or voltage booster 19 to provide higher voltage to the device. This is the basic schematic to get the relay working. Additional components could be added to the schematic in the coil as needed to improve or add functionality of the system.

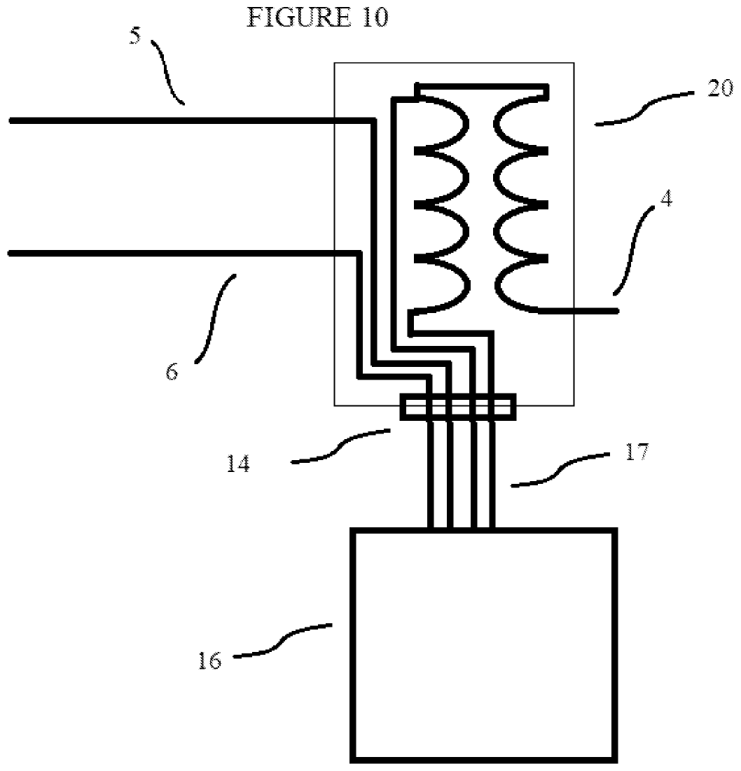

FIG. 10 shows a typical schematic of adding a points amplifier or electronic ignition 16 to the wiring using a multicoil. The ignition coil wires 5 and 6 go to the multicoil in exactly the same way as before the ignition install. This is the basic schematic to get the ignition working. Additional components could be added to the schematic in the coil as needed to improve or add functionality of the system.

Depending on the embodiment, certain of the steps or methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. An apparatus comprising:
an ignition coil comprising:
a transformer;
a housing;
a high voltage output;
a wiring harness connector; and
two or more input terminals;
wherein at least one of the two or more input terminals are electrically coupled to the wiring harness connector and electrically isolated from the transformer; and the transformer is electrically connected to the wiring harness connector.

2. The apparatus of claim 1, wherein the ignition coil further comprises a switching mechanism to couple one or more of the two or more input terminals to either the transformer or to the wiring harness connector.

3. The apparatus of claim 1, wherein the ignition coil further comprises circuitry inline configured to modify electrical signals at the two or more input terminals.

4. An apparatus comprising:
a cover that comprises two or more input terminals; two or more output receptacles; a wiring harness connector;
wherein the cover is configured to fit over an ignition coil with two or more ignition terminals, and to electrically couple the two or more output receptacles to the two or more ignition terminals on the ignition coil;
wherein the two or more input terminals are electrically coupled to the wiring harness connector and electrically isolated from the two or more output receptacles; and the two or more ignition terminals are electrically coupled to the wiring harness connector.

5. The apparatus of claim 4, further comprising a switching mechanism configured to couple the two or more ignition terminals to either the ignition coil or to the wiring harness connector.

6. The apparatus of claim 4, further comprises additional circuitry inline configured to modify electrical signals at the two or more input terminals.

7. The apparatus of claim 4, wherein the cover is made of two or more pieces, with each piece comprising one of the two or more input terminals, output terminal, and the wiring harness connector.

8. The apparatus of claim 4, further comprising a CD ignition and a wiring harness to connect to the wiring harness connector.

9. The apparatus of claim 4, with a relay or voltage booster and a wiring harness to connect to the wiring harness connector.

10. The apparatus of claim 4, further comprising a points amplifier or electronic ignition and a wiring harness designed to connect to the wiring harness connector.

11. The apparatus of claim 1, further composing a CD ignition, and a wiring harness designed to connect the ignition coil to the CD ignition.

12. The apparatus of claim 2, further comprising a CD ignition, and a wiring harness designed to connect the ignition coil to the CD ignition.

13. The apparatus of claim 3, further comprising a CD ignition, and a wiring harness designed to connect the ignition coil to the CD ignition.

14. The apparatus of claim 1, further comprising a relay or voltage booster, and a wiring harness designed to connect the ignition coil to the relay or voltage booster.

15. The apparatus of claim 2, further comprising a relay or voltage booster, and a wiring harness designed to connect the ignition coil to the relay or voltage booster.

16. The apparatus of claim 3, further comprising a relay or voltage booster, and a wiring harness designed to connect the ignition coil to the relay or voltage booster.

17. The apparatus of claim 1, further comprising a points amplifier or electronic ignition, and a wiring harness designed to connect the ignition coil to the points amplifier or electronic ignition.

18. The apparatus of claim 2, further comprising a points amplifier or electronic ignition, and a wiring harness designed to connect the ignition coil to the points amplifier or electronic ignition.

19. The apparatus of claim 3, further comprising a points amplifier or electronic ignition, and a wiring harness designed to connect the ignition coil to the points amplifier or electronic ignition.
